(19) United States
(12) Patent Application Publication
(10) Pub. No.: US 2012/0130154 A1
(43) Pub. Date: May 24, 2012

(54) Voice Volume Modulator

(76) Inventors: Richie Sajan, Baton Rouge, LA (US); Marcio de Queiroz, Baton Rouge, LA (US); Melda Kunduk, Baton Rouge, LA (US)

(21) Appl. No.: 13/298,718

(22) Filed: Nov. 17, 2011

Related U.S. Application Data
(60) Provisional application No. 61/416,387, filed on Nov. 23, 2010.

(51) Int. Cl. G10L 21/06

(52) U.S. Cl. 600/23

(57) ABSTRACT

A small, compact voice volume monitor has been developed that provides feedback to the speaker/user regarding the volume of the user's speech. The monitor is based on a sensing sound vibrations in the ear bone during speech and converting these vibrations into an electrical signal reflecting the speech volume. Electronic circuitry is then used to compare the intensity of this signal with pre-set reference levels. When the intensity of the signal is outside the reference levels for a set amount of time, feedback is provided to the user, for example, from a small vibratory motor.

The benefit of the 23 Nov. 2010 filing date of U.S. Provisional Patent Application 61/416,387 is claimed under 35 U.S.C. §119(e).

This invention pertains to a small, compact voice volume monitoring system that picks up a patient's sound vibrations from bone conduction in the ear, compares the intensity (volume) of the vibrations with both high and low volume thresholds, and provides a simple signal to the user when the vocal volume is too high or too low.

Speech is one of the primary means of human communication and is employed to convey information in a wide range of situations. For effective communication without injuring the vocal system, the speaker's voice should be within a volume range that is neither too high nor too low. The volume of the voice is often affected by disease or ingrained behavior. For example, Parkinson's disease is a chronic disorder of the nervous system that adversely affects motor skills, speech and other physiological functions. Approximately 4 million people suffer from Parkinson's disease and nearly 60,000 new cases are diagnosed every year in the United States alone. Of individuals with Parkinson's disease, at least 75 percent have speech and voice disorders [1]. Speech disorders commonly observed are hypophonia (i.e., reduced loudness of speech), and dysarthria (i.e., a soft, monotone voice and imprecise articulation) [2].

Other speech disorders can be caused as a result of vocal abuse or misuse. One cause of vocal abuse is speaking with excessive loudness which strains or damages the vocal folds. This excessive speech volume can cause vocal nodules, vocal polyps, and laryngitis. Vocal intensity-related voice disorders, for example, vocal nodules and speech intelligibility problems due to lack of volume such as in Parkinson's Disease, can limit quality of life and reduce the patient's ability to interact with family, socialize, or pursue employment [4]. These disorders are widely prevalent and yet easily preventable. Treatments include training to keep the vocal intensity at a reasonable level and teaching of proper speech techniques.

Approaches that currently exist to help with these vocal volume problems include behavioral speech therapies, e.g., the Lee Silverman Voice Treatment (LSVT). In LSVT, a patient with low volume speech performs a series of voice exercises aimed at increasing phonatory effort while receiving feedback from a speech therapist regarding vocal intensity. Studies have shown that increased phonatory effort in Parkinson's patients resulted in a corresponding increase in articulation effort and a return to more normal speech [3]. Therapies like LSVT help patients recalibrate their perception regarding speech output. However, these therapy sessions are expensive, time consuming, and require long-term dedication and assistance from both family members and speech therapists. Unfortunately, this treatment in a clinical setting may not result in improvement in a natural speaking environment when no one is monitoring the patient's speech.

In the LSVT program, patients attend intensive clinical sessions (16 sessions over 4 weeks) and perform speech exercises with a therapist. These sessions are expensive and can be challenging for patients to attend due to the time commitment. The therapy outside the clinic is achieved by a hand-held device that is used for home therapy sessions, but cannot be used in spontaneous communication environments. The current device is designed to help with home exercises that have been given to the patient to practice. The patient looks at a small screen which displays the sound pressure level, frequency and duration of the sustained phonation and speech. This device is not designed to help with spontaneous speech production, but for training/therapy purposes only. Patients need to look at the screen to get information regarding their voice volume, pitch and duration.

Solutions to the vocal abuse problem include complete voice rest or surgical procedures. However neither of these solutions affects the patient's speech pattern that caused the disorder in the first place. These patients need to be trained to speak lower, including learning behavioral voice modification techniques to prevent the occurrence of vocal injury.

U.S. Pat. Nos. 6,231,500 and 5,794,203 describe a biofeedback device for treating stuttering, which detects disfluent speech and provides auditory feedback to the user when stuttering phenomena are detected. In this device, only the user's laryngeal vocal signal is detected and transmitted by one or more of several detectors: a microphone attached to the user's throat, electromyograph electrodes attached to the user's throat, or a standard microphone in which the sound is processed to only transmit the laryngeal sound. Auditory feedback is sent through a headset worn by the user.

U.S. Pat. No. 5,961,443 describes a small, compact device for ameliorating stuttering by providing delayed auditory feedback by picking up the speech sound near the ear, processing the speech to be delayed, and transmitting the speech back to the ear of the user.

U.S. Pat. No. 5,940,798 describes a treatment system for reducing stuttering that uses an auditory feedback modification technique comprising a microphone to pick up the user's speech, a mechanism to delay or perturb the speech pattern, and a headphone or other transmitter to feed the delayed or perturbed speech back to the user.

U.S. Pat. No. 5,927,233 describes a bark control system for training a dog not to bark, with the system consisting of a both a vibration sensor and a microphone either operating independently or in tandem with the vibration sensor gating the microphone; a processor to determine if both the vibration and sound are coming from the targeted dog; and a device to deliver a corrective stimulus to the targeted dog.

U.S. Pat. No. 5,015,179 describes a device for speech training comprising sensing speech using external microphones and providing a digital display of the amplitude of the speech in the form of a series of lights.

U.S. Patent Application Publication No. 2006/0183964 describes a device to monitor vocal intensity (volume) or vocal frequency (pitch) using a throat or lapel microphone which picks up the sound waves, a converter to analyze the frequency and/or intensity, and a mechanism to alert the user when the intensity or frequency is beyond a single threshold. The alert to the user can be visual, tactile and/or auditory. The optional auditory feedback is provided through headphones.

The ability to monitor vocal intensity outside of the clinical setting would greatly aid in the treatment of speech volume disorders. There is a need for a small, compact feedback device that patients can use to monitor the volume of their speech in natural speaking environments.

We have developed a small, compact Voice Volume Monitor (“VVM”) that provides feedback to the speaker/user when the speech volume goes outside a preferred volume range. The monitor has an electroacoustic transducer that senses vibrations in the ear bone during the user's speech and converts these vibrations into an electrical analog signal. Integrated circuitry was used to compare the intensity (volume) of this signal with preset levels for both high and low volume. When the volume was outside the reference levels for a set amount of time, a simple feedback signal was sent to the user. In one embodiment of the VVM, the simple feedback signal was tactile feedback produced by a small vibration motor. Another feedback signal option includes visual feedback using one or more lights. In the VMM, the time delay to send the feedback signal, the high volume reference level, and the low volume reference level were all adjustable.

This simple biofeedback device is a therapeutic tool that is portable, light-weight, and inexpensive. For example, in one embodiment, a small ear vibration microphone was connected via a wire lead to a small plastic housing worn on the waist. The housing contained the integrated circuits to process and compare the signal from the microphone with set threshold levels and to determine whether a signal should be sent to the user. The housing also contained the vibration motor and a power supply, The size of the microphone and housing was small enough not to be intrusive making the device convenient to wear. Patients could monitor and regulate their speech behavior while going about their normal daily routine in an unobtrusive manner to improve vocal communications. The VVM has a variety of potential applications such as providing feedback to singers, lecturers or actors regarding voice volume, or use as a therapeutic tool to treat speech disorders associated with Parkinson's disease and vocal abuse

### BRIEF DESCRIPTION OF DRAWINGS

FIG. 1 is a block diagram of the feedback cycle in one embodiment of the Voice Volume Monitor.

FIG. 2A is a schematic diagram of the microphone circuit used in one embodiment of the Voice Volume Monitor.

FIG. 2B illustrates the voltage level over time of a speech signal obtained from the ear microphone as measured by an oscilloscope.

FIG. 3 is a block diagram of the components of the signal conditioning circuit in one embodiment of the Voice Volume Monitor.

FIG. 4A is a schematic diagram of the non-inverting amplifier circuit used in one embodiment of the Voice Volume Monitor.

FIG. 4B illustrates the voltage level over time of a typical output generated from the non-inverting amplifier as measured by an oscilloscope.

FIG. 5A is a schematic diagram of the inverting amplifier circuit used in one embodiment of the Voice Volume Monitor.

FIG. 5B illustrates the voltage level over time of a typical output generated from the inverting amplifier as measured by an oscilloscope.

FIG. 6A is a schematic diagram of the summing amplifier circuit used in one embodiment of the Voice Volume Monitor.

FIG. 6B illustrates the voltage level over time of a typical output generated from the summing amplifier as measured by an oscilloscope.

FIG. 7A is a schematic diagram of the low-pass filter circuit used in one embodiment of the Voice Volume Monitor.

FIG. 7B illustrates the voltage level over time of a typical output generated from the low-pass filter as measured by an oscilloscope.

FIG. 8 illustrates the voltage level over time for a typical speech signal showing the voltage reference levels—a fixed reference voltage (A) for no speech volume, a high reference voltage (H) for high speech volume, and a low reference voltage (L) for low speech volume.

FIG. 9A illustrates the output from the comparator in normal operation using a reference voltage of 0.35V if the input signal is greater than the reference voltage (an output of +5V) and when the input signal is smaller than the reference voltage (an output of 0.0V).

FIG. 9B illustrates the output from the comparator in switched operation (inputs from the inverting and non-inverting amplifiers are switched) using a reference voltage of 0.8V if the input signal is greater than the reference voltage (an output of +0.0V) and when the input signal is smaller than the reference voltage (an output of +5V).

FIG. 10 illustrates the output from the logic switch during a normal speech pattern but without use of a timing circuit to delay the signal to the motor when the speech pattern is outside the desired volume.

FIG. 11 is a schematic diagram of the integrator circuit used in one embodiment of the Voice Volume Monitor.

FIG. 12A illustrates the output from the microphone indicating the speech volume pattern as shown on an oscilloscope.

FIG. 12B illustrates the output from the control logic circuit before passing through the timing circuit.

FIG. 12C illustrates the output from the integrator circuit which only sends a signal to the comparator once the voltage is above zero for a set time (in this case 3 sec).

FIG. 12D illustrates the comparable output using the integrator circuit, showing that the comparator only sends a signal to the vibrating motor when the speech pattern is outside the desired range for a set period of time.

FIG. 13 illustrates the speech signal as output from the Signal Conditioning Circuit (lower curve) and the signal going to the motor from the timing comparator (upper curve) using a time delay of one sec in this example of speech that falls below the low threshold (L) and above the high threshold (H). Also shown are the reference voltages of a fixed reference voltage (A=0.5V), a high reference voltage (H=3V), and a low reference voltage (L=1V).

FIG. 14A illustrates the speech signal as output from the Signal Conditioning Circuit (lower curve) and the signal going to the motor from the timing comparator (upper curve) using a time delay of one sec in this example of speech that never falls outside the normal range of speech for the full one second and of stopping speech. Also shown are the reference voltages of a fixed reference voltage (A=0.5V), a high reference voltage (H=3V), and a low reference voltage (L=1V).

FIG. 14B illustrates the speech signal as output from the Signal Conditioning Circuit (lower curve) and the signal going to the motor from the timing comparator (upper curve) using a time delay of one sec in this example of speech that falls below the low threshold (L) and above the high threshold (H). Also shown are the reference voltages of a fixed reference voltage (A=0.5V), a high reference voltage (H=3V), and a low reference voltage (L=1V).

FIG. 15 is a schematic of one embodiment of the Voice Volume Monitor.

Our device is an electronic speech therapy aid designed to notify the user when the user's vocal intensity (volume) level goes outside, either above or below, the desired volume range. The voice signal is sensed from the user by means of an ear microphone equipped with a piezoelectric accelerometer to convert the speech bone vibrations into an analog electrical signal. When the user speaks, sound is transmitted via air sound waves but also in the form of vibration waves to the bones in the ear. The ear vibration microphone picks up these bone vibrations and converts them into an analog electrical signal. The microphone analog signal is then analyzed using electronic integrated circuits designed to amplify the signal and to compare the signal to predetermined high and low thresholds. These high and low thresholds are adjustable and can be set by a speech therapist during a clinical session or by the user. If the volume of the user's speech (i.e., the amplitude of the electronic signal from the ear microphone) is above or below the acceptable range (the level between the high and low thresholds) for a set time delay (usually one to four seconds), a signal is sent to notify the user. In the prototype described below, the signal to the user is produced by a small vibration motor, similar to a cell phone or pager vibration motor. The speaker is then notified of the need to regulate the vocal volume back to within the recommended range. In the prototype, both the time delay before vibration and the intensity of vibration were adjustable depending on the preferences of the user. This device can aid in the therapy of voice intensity-related speech disorders by giving patients real-time feedback and helping them recalibrate their vocal levels.

The prototype of the VVM consisted of a small ear microphone and a small plastic housing enclosing the signal processing circuitry, the logic circuitry, the vibration motor, and the power supply. This small housing could be strapped or clipped to the user, for example, at the waist, or placed in a convenient pocket. In the prototype, the ear microphone was physically wired to the housing to send the signal to the circuitry inside. Wireless technology could also be used to send the microphone signal to a receiver in the housing without a physical wire. Using a similar design but smaller circuits, the housing can be made smaller to be worn on the wrist, similar to a watch. In addition, the VVM could in the form of a self-contained earpiece which would hold the microphone and circuitry on a custom integrated circuit. The overall housing size can be decreased by a smaller battery, smaller electrical components, a custom integrated circuit, or use of a programmable microchip.

The VVM is designed for use as a therapy aid to help patients with voice intensity-related speech disorders, specifically speech disorders associated with Parkinson's disease and vocal abuse. The VVM can be used as a supplement to speech therapy sessions by allowing patients to train their voice outside the clinic. The VVM can also be used as a speech therapy aid to help train the speaking voices of patients who regularly over-project their voices, usually because their occupation requires this. Examples of this type of patient include lecturers, announcers, actors, and singers. The VVM could also help with treating excessive loudness in children, where the vibratory feedback could be used as part of a game to encourage them to speak with the appropriate loudness.

The underlying issue with patients suffering from the speech disorders addressed by this device is an inability to receive accurate feedback regarding their own vocal intensity. This is usually caused by deterioration of auditory faculty or other physiological functioning. The VVM addresses this need by providing an external, real-time source of feedback by which the user can confidently speak and regulate vocal intensity.

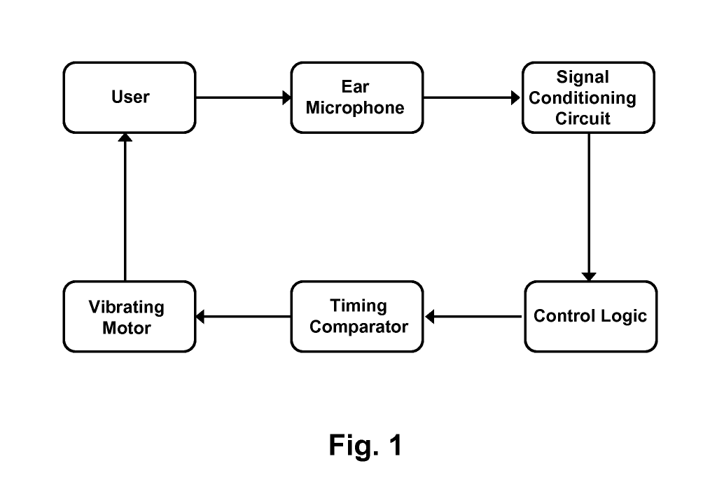

A diagram of the feedback cycle for one embodiment of the VVM is shown in FIG. 1. The feedback cycle in FIG. 1 begins with the user's speech setting off bone vibrations that are detected by the Ear Microphone, which functions as an electroacoustic transducer that converts the user's speech into an electrical signal. This signal is sent to the Signal Conditioning Circuit which amplifies and processes the signal for a smoother and stronger signal for analysis. The processed signal is sent to Control Logic which compares the input signal with preset reference levels and determines if the vocal volume level is within the required range. If vocal volume as represented by the input processed signal is not within the desired range, a signal is sent to the Timing Comparator. The signal must be outside the desired range for a set time delay before the Timing Comparator sends a signal to the Vibrating Motor, alerting the user. When the user feels the vibration, the user knows that the voice volume is outside the set range and can accordingly regulate the speech volume.

The processing components (Signal Conditioning Circuit, Control Logic, and Timing Comparator in FIG. 1) can be realized by using integrated circuits (“hardware”) or by a programmable microcontroller or microchip (“software”). The hardware option uses resistors, capacitors, operational amplifiers, comparators, and logic gates all build into integrated circuits. One embodiment of a hardware option was built as the prototype described below in Example 1. In the software option, a program can be written to perform the math operations of the Signal Conditioning Circuit, Control Logic, and Timing Comparator, and downloaded to a microcontroller chip, which then executes the program code using the microphone input and outputs the control signal to the vibrating motor. The programming language (e.g., C++, Visual Basic) is dependent on the specific microcontroller used.

### EXAMPLE 1

A Prototype Voice Volume Monitor

The prototype described below was built and tested with patients at the Our Lady of the Lake (OLOL) Voice Center in Baton Rouge. Preliminary observations from the use by patients indicate that the patients liked the device for its size, i.e., being small and light weight, and for not interfering with the natural course of communication. The patients indicated they would use the VVM if it was available for them as part of their therapy. Some patients appreciated the device for helping them pay attention to their voice volume, and for helping them notice when and how frequently they raised their voices to an undesired loud volume. The various components of the prototype of the Voice Volume Monitor (VVM) are described individually in detail below.

Ear Microphone: The ear microphone is important as a electroacoutic transducer that converts the sound energy from speech into electrical signals which can be electronically analyzed. Humans hear and transmit sounds through two different pathways: air conduction and bone conduction. External microphones and most non-ear user microphones such as found on a lapel or the throat pick up sound through air conduction. Sound vibrations also cause mechanical vibrations in bone. Each time a vocalization is produced, the resulting sound wave causes the speaker's skull and ear canals to vibrate. An ear vibration microphone is able to detect these vibrations. These vibrations are converted into electrical signals by a piezoelectric sensor within the microphone.

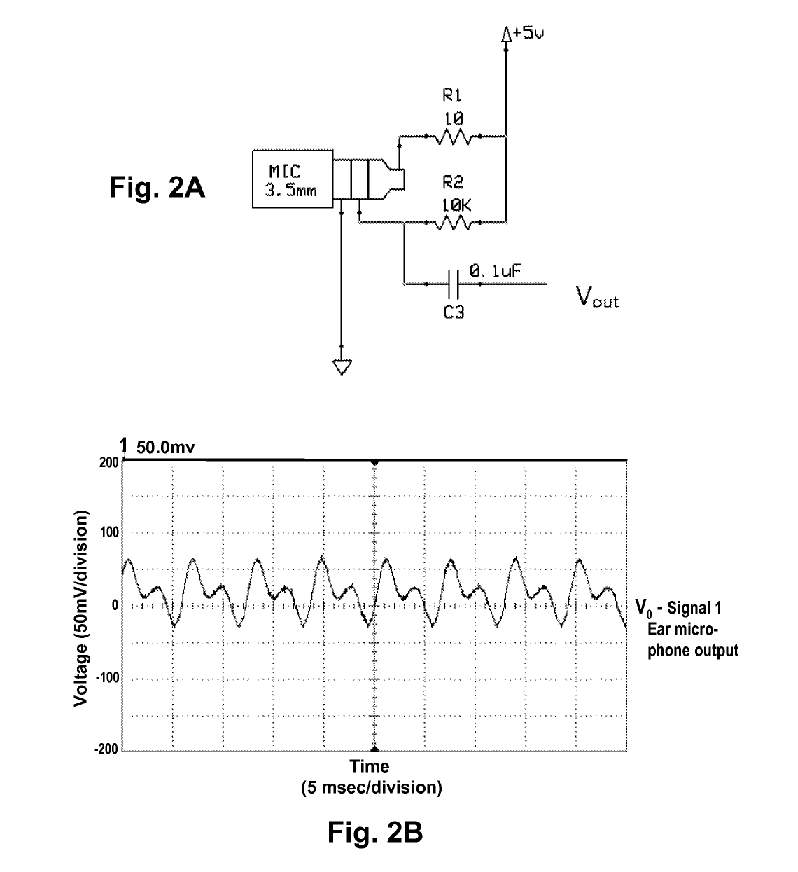

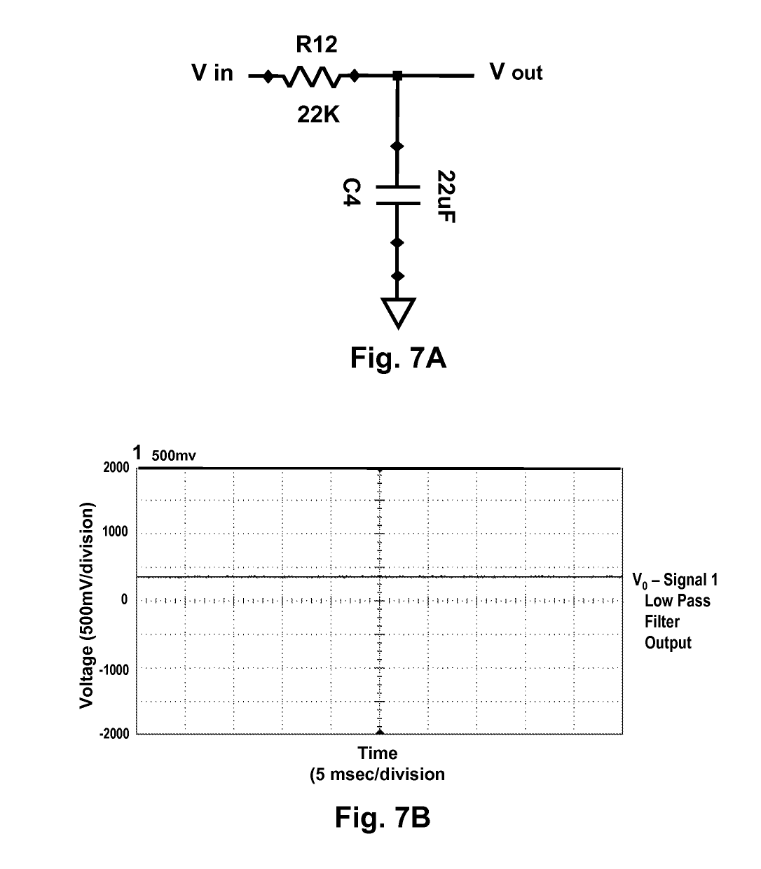

The ear bone microphone was selected because it is unobtrusive and does not interfere with the daily activities of the user. Moreover, using bone conduction as the sound source isolates the sound to coming from the user and prevents interference from external sound sources. Ear microphones based on bone conduction are well known in the acoustic field, e.g., U.S. Pat. Nos. 4,588,867, 4,696,045, and 4,150,262. In the prototype, an off-the-shelf, commercially available ear microphone was used (Ear Bone Vibration Speaker-Microphone; Harvest One Limited, Hong Kong, No: TWRVIBKEN). The ear microphone was modified for one embodiment of the Voice Volume Monitor. In one prototype, a switch was added such that power was provided to the ear microphone only when a Push-To-Talk (PTT) button was held down. In the actual patient testing of the prototype, this switch was disabled so that the microphone was always powered. In another embodiment, the VVM microphone would not have this optional switch and would be always be powered once turned on. Although the prototype ear microphone had the capacity to function as a speaker, only the microphone was necessary for the purposes of the VVM. In the VVM, the speech of the user is not fed back for the user to hear. In addition, although frequency of sound (the “pitch”) can be ascertained from the bone vibration and the signal from the ear microphone, the current embodiment uses only the intensity of the sound (the “volume”). As shown in FIG. 2B, the ear microphone captures the waveform of the voice. The waveform can be characterized by its frequency and amplitude. In the VVM, the waveform is captured by a signal that's proportional to the voice volume (amplitude) (FIG. 7B). If the volume is constant, this signal is constant. In the current embodiment, the device does not need or use the frequency of the original waveform.

The circuit in FIG. 2A shows the configuration of external elements used to obtain a signal from the microphone. The speech signal obtained from the ear microphone was sent to an oscilloscope to visualize the electronic signal voltage over time during speech (Hewlett Packard, Palo Alto, Calif.; model number 54603B (60 MHz)). The same oscilloscope was used to visualize the voltage signals from the other components as described below. A sample of the ear microphone output at 5 msec intervals during a user's speech is shown in FIG. 2B. The regularity of the signal in FIG. 2B is probably due to the short time frame for the wave sample. Since the bone vibrations in the ear bone are small, the magnitude of the electronic signal obtained from the ear microphone is small, in the order of tens of millivolts. The voltage increment in FIG. 2B with each division on the y-axis is only 50 mV (as shown at the top left corner of FIG. 2B). This low voltage and variability of this signal made it hard to analyze. Thus the signal was amplified and smoothed as described below.

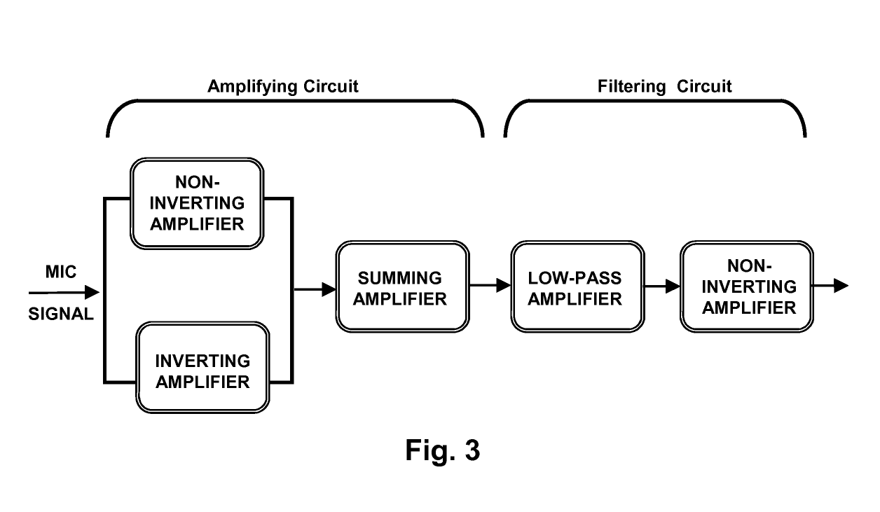

Signal Conditioning Circuit: The purpose of the Signal Conditioning Circuit was to ‘prepare’ the speech signal obtained from the microphone for use with subsequent components. The Signal Conditioning Circuit amplified and processed the signal to a form that could easily be compared with the reference levels. A schematic of the signal flowing through the Signal Conditioning Circuit is shown in FIG. 3. The Signal Conditioning Circuit could be divided into two functioning circuits—the Amplifying Circuit and the Filtering Circuit.

In the prototype, a quadruple operational amplifier (for example, Texas Instruments, Inc., Dallas, Tex.; No: OPA 4353 Integrated Circuit (IC)) was used for four of the amplifiers. This operational amplifier (the “op amp”) had rail-to-rail inputs and outputs and was powered by a single power supply of +5V. The single supply nature of the op amp was an added advantage in that, while both positive and negative signals could be accepted as input to the op amp, only a positive output signal was generated. Because of this feature, these op amps could be used in the inverting and non-inverting amplifier configurations to intrinsically function as half-wave rectifiers without the need for external diodes.

As can be seen from FIG. 2B, the speech signal obtained from the ear microphone had both positive and negative voltage components, the negative component of the signal being smaller than the positive component. Both components were amplified to retain and use as much of the speech signal as possible. FIG. 3 shows the path of the signal from the ear microphone as it passed through the components of the signal conditioning circuit. Each of the parts is described below.

Signal Conditioning Circuit—Amplifying Circuit: Non-Inverting Amplifier: The first op amp functioned as a non-inverting amplifier and amplified the positive component of the speech signal to produce a positive output signal.

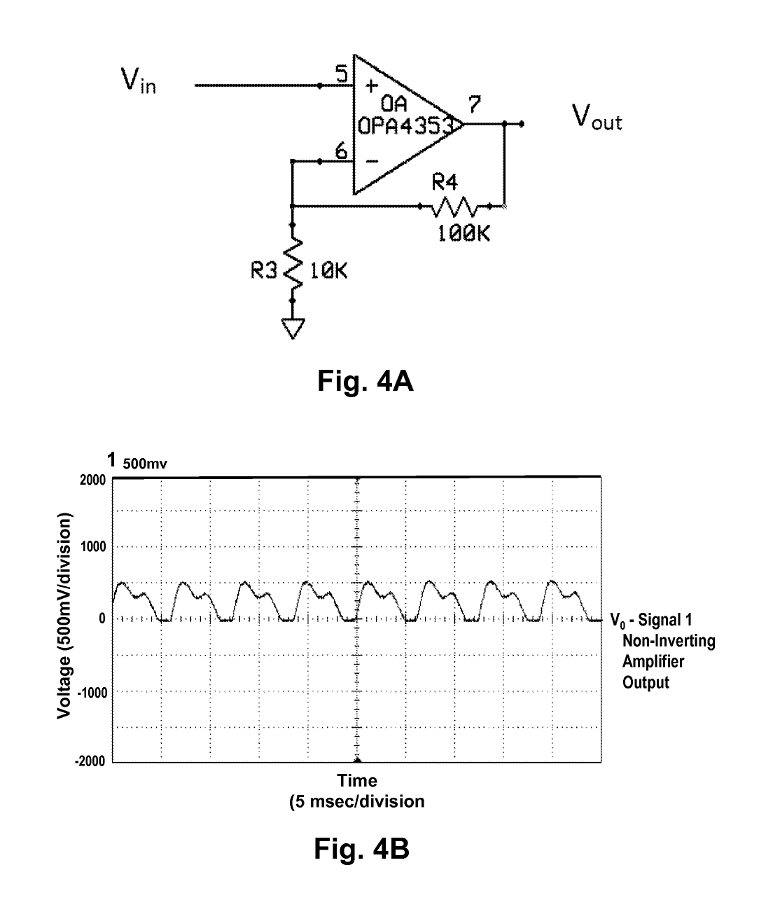

This op amp provided a gain of 11 to the input signal using resistors with values of 10 KΩ and 100 KΩ, arranged as shown in the circuit in FIG. 4A. The gain for this non-inverting amplifier was calculated as shown below:

$$Gain = 1 + \frac{{R}_{4}}{{R}_{3}} = 1 + \frac{100 K}{10 K} = 11$$

As mentioned earlier, the single supply nature of the op amp ensured that only the positive component of the speech signal was amplified while the negative was set to zero. FIG. 4B shows the output generated from the non-inverting amplifier as measured by an oscilloscope from an input signal as shown in FIG. 2B. In this graph, the voltage increment with each block is 500 mV, reflecting the increase in the order of magnitude of the signal as amplified over the signal in FIG. 2B. As shown in FIG. 4B, the input signal was amplified and retained only the positive voltage of the input signal.

Signal Conditioning Circuit—Amplifying Circuit: Inverting Amplifier:

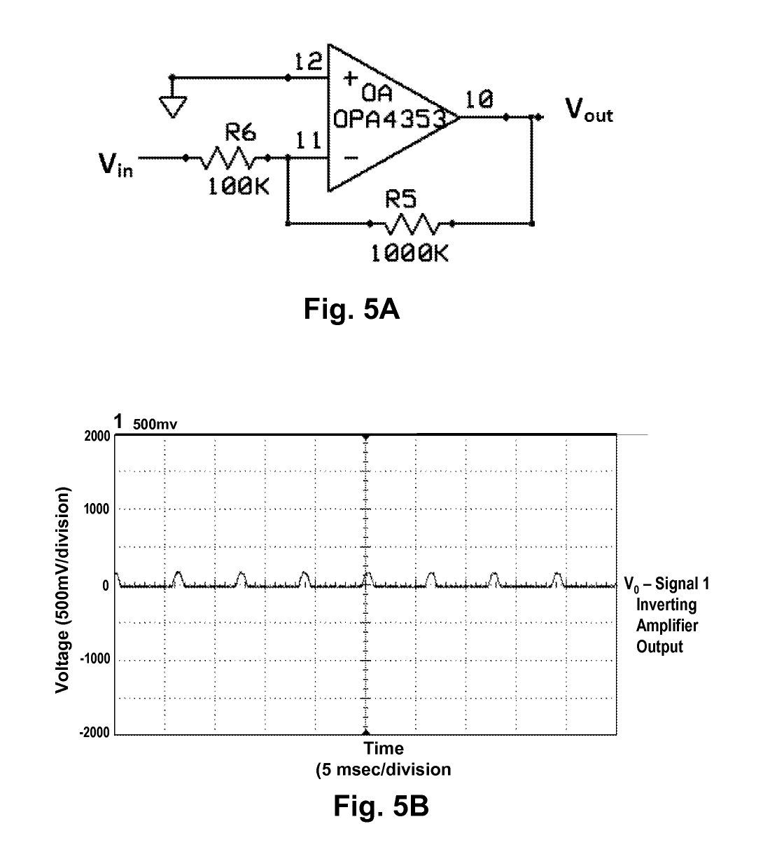

The second op amp, with a circuit as shown in FIG. 5A, functioned as an inverting amplifier. This inverting amplifier amplified the negative component of the speech signal, and inverted the signal to provide a positive output signal.

This op amp provided a gain of 10 to the input signal using resistors with values of 100 KΩ and 1000 KΩ, arranged as shown in the circuit. The gain for inverting amplifiers was calculated as shown below:

$$Gain = - \frac{{R}_{5}}{{R}_{6}} = - \frac{1000 K}{100 K} = - 10$$

The negative sign of the gain indicates the inversion of the signal. The inverting amplifier amplified and inverted both positive and negative components of the signal. However, the single supply nature of the op amp ensured that only the positive component of the inverted and amplified signal (the original negative component) was generated as output. FIG. 5B shows the output generated from the inverting amplifier as shown on an oscilloscope from an input signal as shown in FIG. 2B. In this graph, the voltage increment with each block is 500 mV, again reflecting the increase in the order of magnitude of the signal when compared to FIG. 2B. As shown in 5B, the input signal was inverted and amplified, and the output only reflects the negative voltage seen in FIG. 2B.

While both amplifiers provided a gain of approximately 10, the inverting amplifier used higher values of resistance (100 KΩ, 1000 KΩ) than the non-inverting amplifier (10 KΩ, 100 KΩ) to increase the efficiency of transmission of the signal. Signal transmission efficiency increases when the input impedance (“resistance” seen by the signal as it enters a component) is high (called “impedance bridging”). For the inverting amplifier, the input impedance was determined by the resistance at the negative input, (R6) in FIG. 5A; therefore a relatively higher value (100 KΩ) was chosen for this resistor.

For the non-inverting amplifier however, impedance bridging did not influence the choice of external resistor values since there were no resistors in the path of the signal as it entered the op amp (FIG. 4A). Therefore the input impedance was determined by the impedance of the op amp itself. In the case of the Texas Instruments OPA 4353 IC used in the prototype, the impedance was approximately 10¹³Ω. This high impedance was sufficient for efficient transmission of the signal.

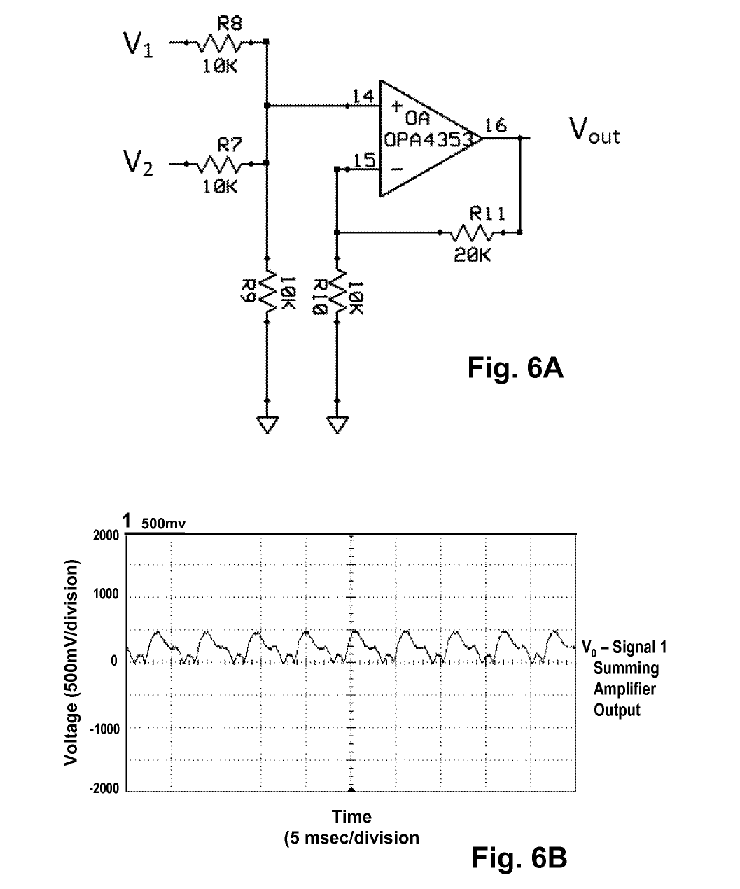

Signal Conditioning Circuit—Amplifying Circuit: Summing Amplifier: The outputs from the inverting and non-inverting amplifiers were then combined to form a positive amplified signal using a summing amplifier (FIG. 3). The outputs from the inverting and non-inverting amplifiers were provided as inputs to the summing amplifier, the third op amp, with a circuit as shown in FIG. 6A. The configuration shown in FIG. 6A allowed this op amp to function as a non-inverting summing amplifier. The summing amplifier merely added the output signals from both the inverting and non-inverting amplifiers. FIG. 6B shows the output from the summing amplifier as measured on an oscilloscope when the original input signal was as shown in FIG. 2B. As shown in FIG. 6B, the voltage graph is the sum of the graphs shown in FIGS. 4B and 5B. The combination of the inverting, non-inverting and summing amplifiers essentially acted as a full-wave rectifier with a gain of approximately 10.

Signal Conditioning Circuit—Filtering Circuit: Low-Pass Filter Circuit: The fully amplified and rectified signal as shown in FIG. 6B was still not in a form to be analyzed easily. To obtain a representative measure of the signal amplitude and smooth out the peaks and troughs seen in FIG. 6B, the signal was then passed through a passive, low-pass filter with a circuit as shown in FIG. 7A, consisting of a resistor (R12) and capacitor (C4).

This low-pass filter circuit attenuated signals with high frequencies and allowed low frequency signals to pass. The low-pass filter performed the function of providing a moving average of signal volume, capturing the general trend of the voice intensity while ignoring the peaks and troughs. The values of the resistor (22 KΩ) and capacitor (22 μF) were selected to eliminate the ripples in the signal. FIG. 7B shows the output of the low-pass filter as shown on the oscilloscope. This output is an average of the output from the summing amplifier signal that was shown in FIG. 6B.

The cut-off frequency for this circuit is given by:

$$fc = \frac{1}{2 π {R}_{12} {C}_{4}} = 0.33 Hz$$

This filtered signal then passed through a fourth op amp which functioned as another non-inverting amplifier. The gain for this amplifier could be varied using a potentiometer (variable resistor) (No. 3386X-1-103TLF, Bourns Inc., from Digikey, Thief River Falls, Minn.). This fourth amplifier was added to the circuit to provide a simple means of adjusting the gain of the final conditioned signal, which can be used to improve the sensitivity of the device without having to change resistors at multiple stages.

Control Logic: The heart of the VVM lies in the Control Logic which was implemented, in the prototype, using a quadruple comparator integrated circuit (IC) (Texas Instruments, Inc., Dallas, Tex.; No. TLC3704 IC) and a logic function IC (Texas Instruments, Inc., No: SN74LVC1G0832). Three comparators of the quadruple comparator were used to compare the speech signal from the Signal Conditioning Circuit (i.e., the final amplified, smoothed signal) to three threshold voltages. The Control Logic IC then analyzed the output from the three comparators and generated an output voltage only when the speech signal was at a level where the user was to be notified.

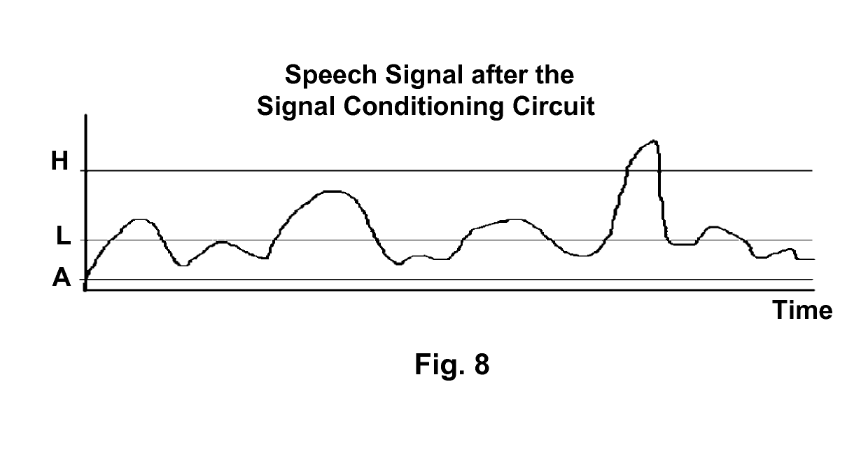

Control Logic—Comparators: The output signal from the Signal Conditioning Circuit was provided as input to the first three comparators in the quadruple comparator IC. Each of the three comparators compared this signal with an adjustable reference level—‘A’, ‘L’ or ‘H’. In the prototype, ‘A’ was a fixed reference voltage adjusted to be just above the quiescent voltage of the microphone (in the prototype, A was set at 0.2 V). When the user was not speaking, the microphone output was slightly lower than 0.2 V, and when the user began speaking, the signal exceeded 0.2V. Thus, ‘A’ was used to differentiate between when the user was not speaking and when the user was speaking too softly. The second comparator compared the signal with the ‘L’ reference level. “L” represented the ‘LOW’ reference voltage which defined the minimum desired vocal intensity, and could be adjusted depending on the user. If the voice signal went below this reference level, the user was speaking at a level that was too soft, and feedback was required. Finally, the third comparator compared the signal with the ‘H’ reference level. “H” represented the ‘HIGH’ reference voltage which defined the maximum desired vocal intensity. If the voice speech signal went above this reference level, the user was speaking at a level that was too loud, and again the user should be notified. Between the ‘L’ and ‘H’ reference voltages was the signal voltage representing the vocal range that the user was trying to maintain. FIG. 8 shows the relative positions of the three reference levels with respect to a typical speech signal from the Signal Conditioning Circuit.

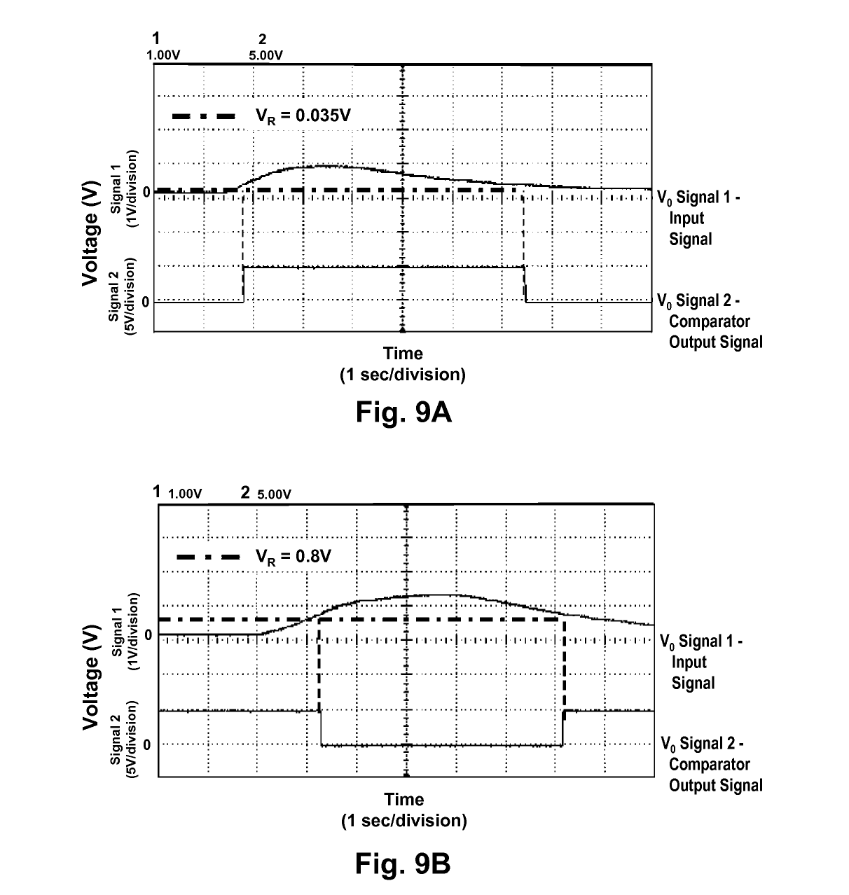

The output from each comparator is a digital signal. In the prototype, the output signal was +5V if the input signal was greater than the reference voltage, and 0.0V if the input signal was smaller than the reference voltage. This is shown in FIG. 9A, where signal 1 is the input signal to the comparator, and signal 2 is the comparator output. In FIG. 9A, the reference voltage setting for the comparator was 0.35V. Thus if the input signal exceeded 0.35V, then the comparator output was +5V. However, If the inverting and non-inverting inputs of the comparator are switched, the comparator will perform in the opposite manner, generating 0.0V if the input signal is greater than the reference voltage and +5V if the input signal is smaller, as shown in FIG. 9B. In FIG. 9B, the reference voltage was adjusted to 0.8V. If the input signal was greater than 0.8V, the output signal from the comparator was 0.0V, but if the input signal was lower than 0.8V, the output signal was +5V.

Two of the comparators, ‘A’ and ‘H’, were set in the “normal” configuration to perform as shown in FIG. 9A. The third comparator ‘L’ used the “switched” configuration shown in FIG. 9B. This switched configuration for comparator “L” was employed to simplify the logic to determine whether to notify the user. With the comparators in this arrangement, the comparator outputs for the possible positions of the input signal are shown in Table 1 where “1” represents V₀=+5V; and “0” represents V₀=0.0V.

TABLE 1
Comparator Outputs

| | Outputs | | |
|---|---|---|---|
| | Comparator | Comparator | Comparator |
| Speech signal position | ‘A’ | ‘L’ | ‘H’ |
| Below reference level ‘A’ | 0 | 1 | 0 |
| Between ‘A’ and ‘L’ | 1 | 1 | 0 |
| Between ‘L’ and ‘H’ | 1 | 0 | 0 |
| Above ‘H’ | 1 | 0 | 1 |

Control Logic—Logic IC: The digital outputs from the three comparators were analyzed by the Logic IC such that an output signal was generated only if the input signal was either between ‘A’ and ‘L’ or was above ‘H’, which are the two ranges of speech volume where the user needed to be notified. The following logic function yields an output signal at the appropriate vocal intensity levels

Y=(A·L)+H

where A, L, H are the comparator outputs
Y is the logic IC output
‘·’ represents the ‘AND’ Boolean operator
‘+’ represents the ‘OR’ Boolean operator

The different comparator output possibilities after using this logic operation are listed in Table 2. When the logic output Y is 1, a +5V signal is sent to the motor. A 0.0V signal or no signal is sent when the output Y is 0.

TABLE 2
Logic Output

| | Comparator Outputs | | | Logic Output |
|---|---|---|---|---|
| Input Signal | A | L | H | Y |
| Above H | 1 | 0 | 1 | 1 |
| Between L and H | 1 | 0 | 0 | 0 |
| Between A and L | 1 | 1 | 0 | 1 |
| Below A | 0 | 1 | 0 | 0 |

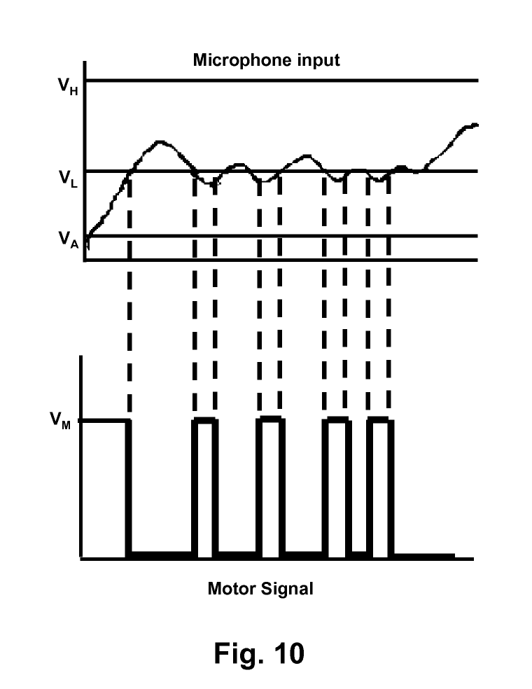

Timing Comparator: In the configuration of the prototype, the switching time of the Logic IC was almost instantaneous. As a result, a fluctuating speech signal would cause a rapid on-off switching of the motor each time the signal passed a threshold voltage. This undesirable trait is amplified with the wave-like nature of a normal speech signal. As shown in the schematic situation in FIG. 10, the signal to the motor would be frequent and instant with a speech input signal that moved out of the normal range for even a very short time. The timing comparator IC was added to address this issue and to ensure that the user was outside the normal range of speech for a set period of time before a signal would be sent to the vibration motor. This time delay was adjustable in the prototype from about 1 sec to about 4 sec.

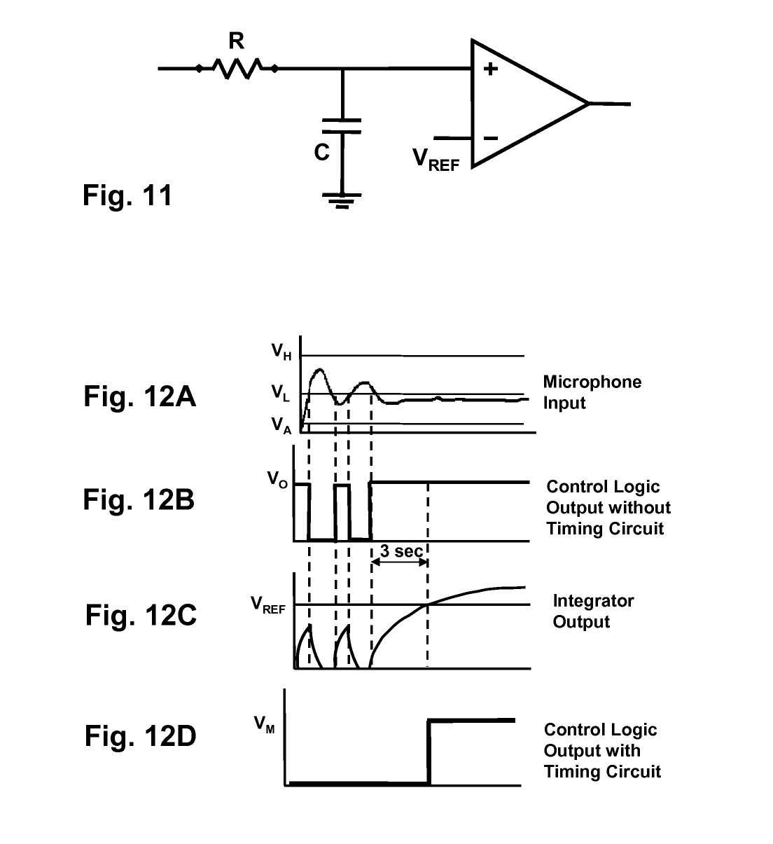

In the prototype, the output signal from the Logic IC passed through the timing comparator IC which had both an integrator circuit, which consisted of a resistor and capacitor in the configuration shown in FIG. 11, and a comparator. The combination of the integrator circuit and comparator set the time delay for the signal to be sent to the motor. FIGS. 12A-D show the output of the VVM at various stages. FIG. 12A shows the signal input from the Signal Conditioning Circuit. FIG. 12B shows the output signal from the Control Logic IC to the motor without a timing comparator IC. FIG. 12C shows the output from the integrator circuit, and demonstrates that when a constant signal was sent to the integrator circuit, the output was a gradually increasing voltage signal. The time delay for the timing comparator was 3 sec. The integrator output was sent to a comparator which sent an output signal to the motor once the voltage from the integrator reached a certain threshold (V_{REF} in FIG. 12C). The output of the comparator with the integrator circuit is shown in FIG. 12D. The rate at which the signal increased could be changed by adjusting the value of the resistor (R) in FIG. 11. Thus by adjusting the resistor value the time delay before the onset of vibration of the motor could be adjusted, preferably from about 1 sec to about 4 sec. The resister was adjusted by using a potentiometer. The timing comparator and integrator only delayed the onset of voltage going to the vibration motor (i.e., turning the vibration on). The loss in voltage once the input signal was back in normal range was not delayed (i.e., turning the vibration off). The timing comparator was the fourth comparator in the quadruple comparator first used in the Control Logic part of the circuit.

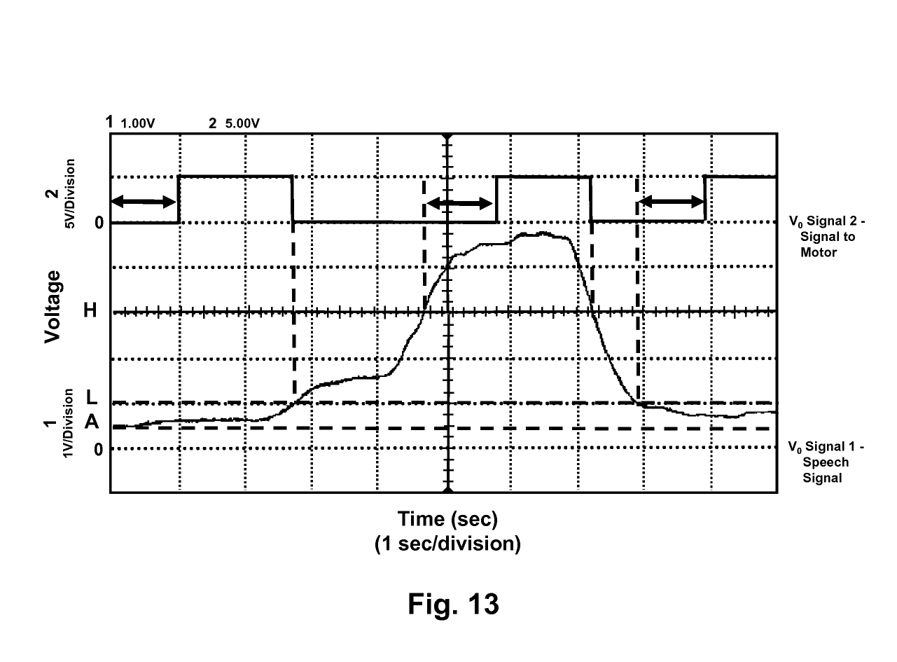

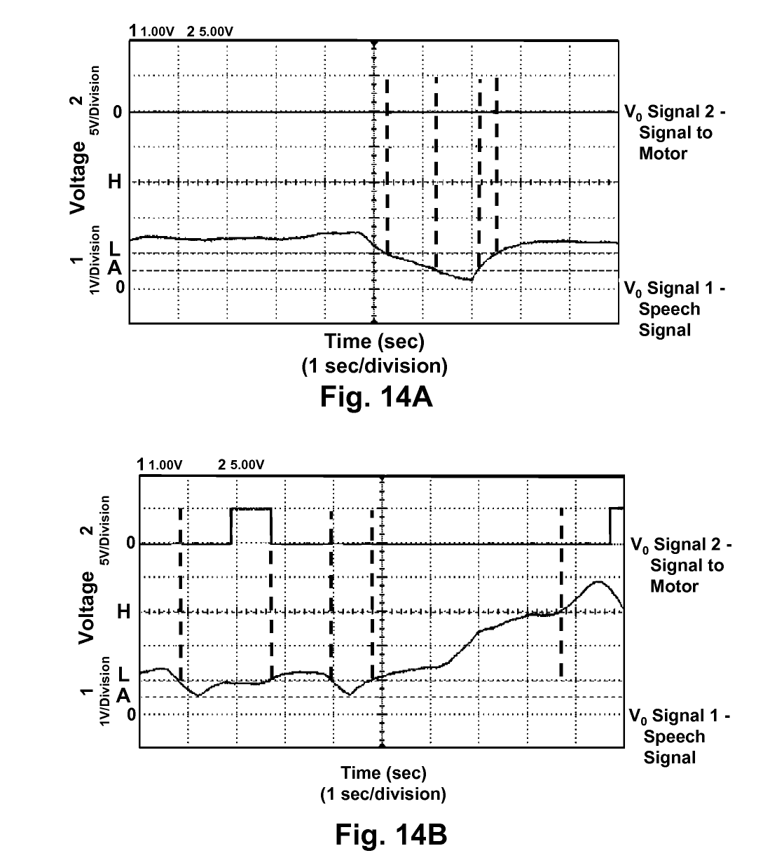

FIGS. 13 and 14A-B show graphs of output data from operation of the VVM. Signal 1 (lower signal in FIGS. 13 and 14A-B, as shown on the right axis) is the speech signal as measured by the voltage output from the Signal Conditioning Circuit; and signal 2 (upper signal in FIGS. 13 and 14A-B) is the signal going to the motor as the output voltage from the timing comparator. The reference voltages used in the prototype to generate FIGS. 13, 14A and 14B, were A=0.5 V, L=1 V and H=3 V with the time delay set at 1 sec before the onset of vibration. FIG. 13 shows a graph of the output to the motor with a signal input that spans 3 vocal ranges (between ‘A’ and ‘L’, between ‘L’ and ‘H’, and above ‘H’). The user started off speaking too soft (between ‘A’ and ‘L’), and a signal was sent to the motor after approximately 1 sec (the gridlines divide the x-axis in 1 sec increments). When the user's voice rose to the desired level (between ‘L’ and ‘H’), the motor output stopped almost instantaneously. When the user's voice became too loud (above ‘H’), the signal was again sent to the motor after 1 sec. The signal stopped immediately as the user recognized the motor vibration and lowered the speech volume below H. When the volume dropped below ‘L’ again, the motor again began to vibrate after 1 sec.

FIG. 14A shows the graph of the input signal and output to the motor when the user was speaking within the appropriate vocal range (between ‘L’ and ‘H’). When the user stopped speaking, the speech signal dropped below ‘L’ momentarily, but proceeded below ‘A’ in less than 1 second, thereby not triggering a signal to the motor. When the user next began speaking, the voice signal quickly rose above ‘L’ in less than 1 second, and prevented the triggering of the motor. In this manner, the prototype of the Voice Volume Monitor was designed to allow for normal speech with minimal interruption, while notifying the user only in the case of a real issue. FIG. 14B is another sample in which the user began speaking in the desired range, but then lowered the voice for more than 1 sec which triggered a signal to the motor. The user brought the voice volume up, then dropped the volume again but not for a full second. Then the user continued to speak in the desired range until increasing the volume above the H level for more than 1 sec, again triggering the signal to the motor.

The components of the circuit in the prototype were selected such that a single power supply of +5 volts was sufficient. In the prototype, the power was provided by a 9V battery with the voltage regulated down to 5V using a voltage regulator IC (Texas Instruments, No. LP2981-50).

Vibration Motor: When the user's voice dropped below the preset Low volume level (‘L’) or rose about the preset High (‘H’) volume level for the set time delay, an output voltage was sent to a vibration motor from the timing comparator. Vibration motors are well known in the telecommunication filed, for example, in cell phones and pagers. The prototype used a commercially available vibration motor (Precision Microdrives, part number 310-101; from SparkFun Electronics, Boulder, Colo.). A motor driver (Maxim Integrated Products, Inc., part number MAX1749; from Digikey, Thief River Falls, Minn.) was used to provide appropriate current to the motor when it received a voltage. Any small vibration motor could be used that would respond to the signal from the timing comparator.

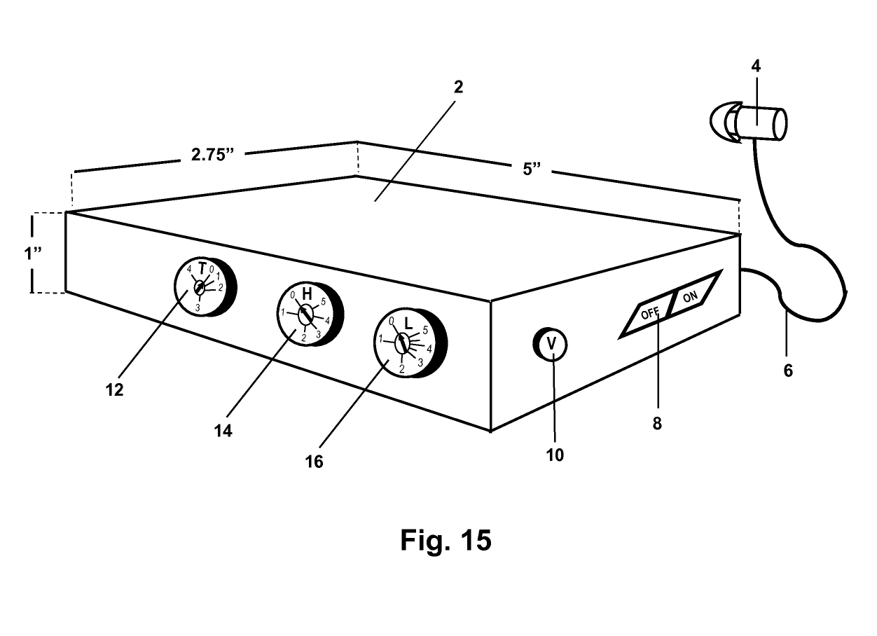

Device Housing: The Signal Conditioning Circuit, Control Logic, Timing Comparator, Vibrating Motor and power supply were enclosed in a small compact housing (5″×2.75″×1″; Serpac Electronic Enclosures, part number H659VPC; from Digikey, Thief River Falls, Minn.). FIG. 15 illustrates the prototype showing plastic housing 2 attached to ear microphone 4 using wire lead 6. The outside of the housing 2 had three dials on the side allowing certain adjustments. The “T” dial 12 could be turned to adjust the time delay between when the input signal crossed a threshold level and when the motor vibrated, a time delay from about 1 sec to about 4 sec. The “H” dial 14 was used to adjust the high threshold voltage for the input signal and was calibrated from about 0.0V to about 5V. The “L” dial 16 was used to adjust the low threshold voltage for the input signal and was calibrated from about 0.0V to about 5V. In addition, on the front of housing 2 was on/off button 8 and V dial 10 to adjust the speed of vibration from the motor. Housing 2 with all its inner components was easily worn on the belt or in a pocket of the user.

Other embodiments of the VVM could be built using similar logic but smaller components. For example, one embodiment could have a housing that fits in and around the ear, where the vibration would be felt or heard around the ear. Another embodiment could have ear microphone 2 linked to a housing worn on the wrist. Another configuration would take advantage of wireless technology so that the signal from ear microphone 4 to housing 2 would be transmitted without use of a lead or wire. The overall size of the housing could be decreased by replacing the integrated circuits with a microchip processor that is programmed to perform similar logic functions as disclosed above.

### REFERENCES

1. Ramig, L. O., (2002). Speech, Voice and Swallowing Disorders. Parkinson's Disease: Diagnosis and Clinical Management, 9.
2. Kent, Raymond D., ed. (2003). The MIT Encyclopedia of Communication Disorders. Cambridge: The MIT Press.
3. Kleinow, J., (2001). Speech Motor Stability in IPD: Effects of Rate and Loudness Manipulations. Journal of Speech, Language and Hearing Research, Vol. 44, 1041-1051.
4. Oxtoby M. (1982) Parkinson's Disease Patients and Their Social Needs. London: Parkinson's Disease Society.

The complete disclosures of all references cited in this specification are hereby incorporated by reference. Also incorporated by reference is the complete disclosure of the following: R. Sajan, “A portable phonatory feedback device for patients with speech disorders,” an abstract submitted for the 2010 Mechanical Engineering Student Conference, Apr. 10, 2010; and R. Sajan, “A Portable Phonatory Feedback Device for Patients with Speech Disorders,” a thesis submitted to Louisiana State University, Department of Mechanical Engineering on December 2010. In the event of an otherwise irreconcilable conflict, however, the present specification shall control.

What is claimed:

1. A voice volume monitor for alerting a patient when the patient's vocal volume is too high or too low, said device comprising:
a. a mechanical vibration sensor mounted in the patient's ear to sense bone vibration and to transmit a signal proportional to the vocal volume;
b. a processing center to receive and compare the transmitted signal to each of a pre-set high volume reference and a pre-set low volume reference; and
c. a stimulus delivery system to send an alert stimulus to the patient if the transmitted signal is higher than the pre-set high volume reference for a predetermined time interval; and to send an alert stimulus to the patient if the transmitted signal is lower than the pre-set low volume reference for a predetermined time interval.

2. The voice volume monitor of claim 1, wherein the transmitted signal is transmitted by a wire lead.

3. The voice volume monitor of claim 1, wherein the transmitted signal is transmitted wirelessly.

4. The voice volume monitor of claim 1, wherein the pre-set high volume reference is adjustable.

5. The voice volume monitor of claim 1, wherein the pre-set low volume reference is adjustable.

6. The voice volume monitor of claim 1, wherein the predetermined time interval is from about one second to about four seconds.

7. The voice volume monitor of claim 1, wherein the predetermined time interval is about three seconds.

8. The voice volume monitor of claim 1, wherein the alert stimulus sent to the patient if the transmitted signal is higher than the pre-set high volume reference is a different alert stimulus than the alert stimulus sent to the patient if the transmitted signal is lower than the pre-set low volume reference.

9. The voice volume monitor of claim 1, wherein the alert stimulus sent to the patient if the transmitted signal is higher than the pre-set high volume reference is the same alert stimulus than the alert stimulus sent to the patient if the transmitted signal is lower than the pre-set low volume reference.

10. The voice volume monitor of claim 1, wherein the alert stimulus sent to the patient is a tactile stimulus.

11. The voice volume monitor of claim 10, wherein the tactile stimulus sent to the patient is a vibration.

12. The voice volume monitor of claim 1, wherein the alert stimulus sent to the patient is a visual stimulus.

13. The voice volume monitor of claim 12, wherein the visual stimulus sent to the patient is one or more lights.

14. The voice volume monitor of claim 1, wherein the processing center and the stimulus delivery system are enclosed in a housing.

15. The voice volume monitor of claim 14, wherein the housing is worn on the waist of the patient.

16. The voice volume monitor of claim 14, wherein the housing is worn on the wrist of the patient.

17. The voice volume monitor of claim 14, wherein the housing is worn near the ear of the patient.

18. The voice volume monitor of claim 1, wherein the processing center consists of one or more integrated circuits.

19. The voice volume monitor of claim 1, wherein the processing center consists of one or more programmable microchips.
